(19) United States
(12) Patent Application Publication
(10) Pub. No.: US 2024/0416983 A1
(43) Pub. Date: Dec. 19, 2024

(54) Reconfigurable Materials Handling Cart

(71) Applicant: Mark Kinley, Danville, KY (US)

(72) Inventor: Mark Kinley, Danville, KY (US)

(21) Appl. No.: 18/741,905

(22) Filed: Jun. 13, 2024

Related U.S. Application Data
(60) Provisional application No. 63/472,687, filed on Jun. 13, 2023.

(51) Int. Cl. B62B 3/02

(52) U.S. Cl. CPC B62B 3/02; B62B 2205/06

(57) ABSTRACT

A materials handling cart is provided. The materials handling cart includes a first platform connected to a second platform via a pair of crisscrossed arms, whereby the second platform is configurable between a closed position with the first platform and an open position wherein the second platform is spaced from the first platform. It also includes a base including a first set of wheels, a cross bar connected to the base via a first arm and a second arm, and a second set of wheels connected to the first platform. The materials handling cart is configured to change between the closed position and the open position.

This application claims the benefit of U.S. Provisional Patent Application Ser. No. 63/472,687, filed on Jun. 13, 2023, the disclosure of which is incorporated herein by reference.

### TECHNICAL FIELD

This disclosure relates generally to the field of materials handling devices and, more particularly, to a versatile cart that is transformable into multiple materials handling devices, including a dolly, a flatbed truck or trolley, and an adjustable height lift cart.

### BACKGROUND

It is well known that professional handymen and repairmen, general contractors and subcontractors, healthcare workers, manufacturing industry workers, office environment workers, home owners and individuals that perform numerous tasks in and around a house or job site need versatile equipment to perform a multitude of tasks at the work or job site or around the house. One common piece of equipment is a materials cart, which is often used in transporting products, industrial loads, and materials. Unfortunately, traditional materials carts often serve a single use purpose, i.e., transport of materials in one particular type of configuration. In a home improvement job or other work site, the worker or individual may need multiple accessories, such as a dolly, hand truck and lift cart. However, it is expensive to purchase and bring multiple different pieces of equipment to the home, office, or work site.

If the worker or individual purchased and/or took each of these pieces of equipment to his home or place of work, it would take significant time and expense. Furthermore, the need for a variety of accessories clutters up the work space and occupies limited and valuable space in the work space and the transport vehicle. Moreover, all the necessary accessories may not be able to be transported to a work site and an accessory may be forgotten before leaving for the job or at the job site, which necessarily results in decreased efficiency in terms of costs and time delay. Consequently, the need for the variety of accessories results in increased costs and decreased productivity.

Accordingly, there is a need for a more efficient, versatile multi-purpose accessory cart that is capable of being reconfigured into multiple configurations for performing different material handling and transport functions. Advantageously, the multi-purpose accessory cart increases efficiency during the performance of the job by reducing the stoppage of work to switch between carts for completion of the various tasks. The multi-purpose accessory cart also eliminates the need to carry multiple carts and may fit within the worker's pocket or small compartment for storage.

### SUMMARY

In accordance with one aspect of the disclosure, a materials handling cart is provided. The materials handling cart includes a first platform connected to a second platform via a pair of crisscrossed arms, whereby the second platform is configurable between a closed position with the first platform and an open position wherein the second platform is spaced from the first platform. It also includes a base including a first set of wheels, a cross bar connected to the base via a first arm and a second arm, and a second set of wheels connected to the first platform. The materials handling cart is configured to change between the closed position and the open position.

In one possible embodiment, a rear guard may be connected to the first platform. The first and second platforms may be made of metal. The first and second platforms may be parallel to one another in the open position and the closed position. The pair of crisscrossed arms are collapsed between the first and second platforms in the closed position, while the pair of crisscrossed arms are extended in a X-shape between the first and second platforms in the open position. In one embodiment, the closed position is a dolly position, while in another embodiment the closed position is a flatbed hand truck position. The open position is an adjustable height lift cart position.

In accordance with another aspect of the disclosure, a reconfigurable utility cart movable between a first arrangement, a second arrangement, and a third arrangement is provided. The reconfigurable utility cart includes a top platform and a bottom platform, wherein the first and second platforms are joined by a pair of scissor lift support bars. The reconfigurable utility cart further includes a support bar including a plurality of front wheels, a cross bar connected to the support bar via a first arm and a second arm, a plurality of rear wheels fixed to the bottom platform, and a plate connected to the top platform.

In one possible embodiment, the top platform is configured to stack on top the bottom platform in the first arrangement and the second arrangement. The pair of scissor lift support bars fit between the first and second platforms in a closed position in the first arrangement and second arrangement. The first and second arms and the support bar may be configured to swing away from the top and bottom platform such that the top and bottom platforms form an acute angle with the first and second arms. The acute angle may be a substantially 45 degree angle. The cart may include a fixed pivot joint at the center of each pair of scissor lift support bars, allowing compression and extension of the scissor lift support bars between varying arrangements. Each pair of scissor lift support bars are configured into an extended position such that the top and bottom platforms are spaced apart in the third arrangement. The plurality of rear wheels may be larger than the plurality of front wheels. The plurality of rear wheels are fixedly mounted to the support bar, while the plurality of front wheels are castor wheels.

In accordance with yet another aspect of the disclosure, a method for configuring a materials handling cart from a first position to a second position to a third position is provided. The method includes the steps of: (i) providing a top platform and a bottom platform including a pair of X-shaped arms, a base including a first set of wheels, a cross bar connected to the base via a first arm and a second arm, a second set of wheels connected to the first platform; (ii) positioning the top and bottom platforms in a stacked configuration such that the top and bottom platforms are parallel with the ground in a first position; (iii) extending the top and bottom platforms to the cross bar such that the top and bottom platforms are perpendicular with the ground in a second position; (iv) returning the top and bottom platforms to the first position; and (v) extending the pair of X-shaped arms via a central fixed pivot such that the top and bottom platforms are spaced apart in a third position.

### BRIEF DESCRIPTION OF THE DRAWINGS

The accompanying drawings incorporated in and forming a part of the specification, illustrate several aspects of this disclosure, and together with the description serve to explain the principles of the disclosure. In the drawings:

FIG. 1 is a front perspective view of a multi-purpose accessory cart in an upright, dolly configuration forming one aspect of this disclosure;

FIG. 2 is a side perspective view of the multi-purpose accessory cart in an angled, dolly configuration forming one aspect of this disclosure;

FIG. 3 is a side view of the multi-purpose accessory cart in a flatbed hand truck configuration forming one aspect of this disclosure; and

FIG. 4 is a side view of the multi-purpose accessory cart in an adjustable height lift cart configuration forming one aspect of this disclosure.

### DETAILED DESCRIPTION

In the following detailed description, reference is made to the accompanying photographs that form a part hereof, and in which is shown by way of illustration, specific embodiments in which the invention may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the invention is defined only by the appended claims and their equivalents. In accordance with the disclosure, a versatile, multi-purpose materials handling cart is hereinafter described.

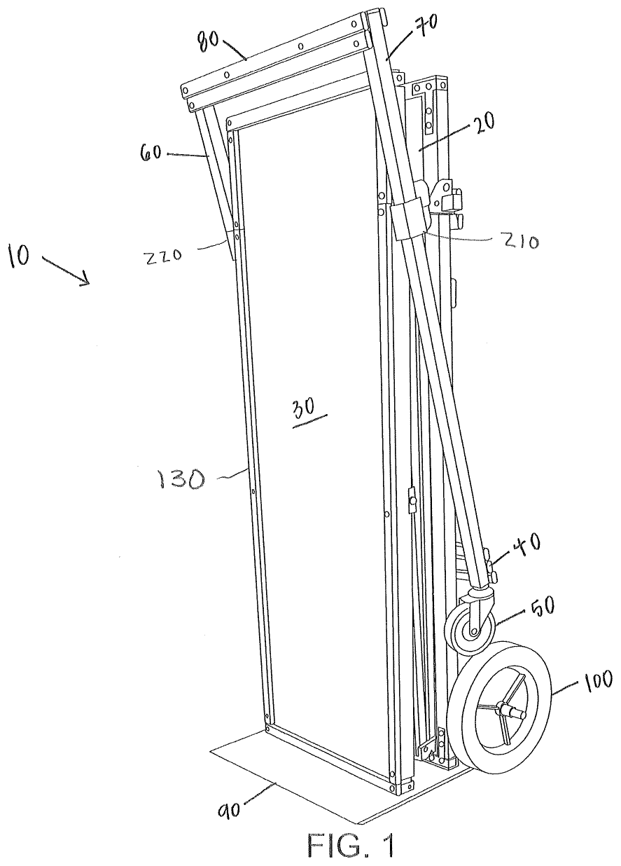

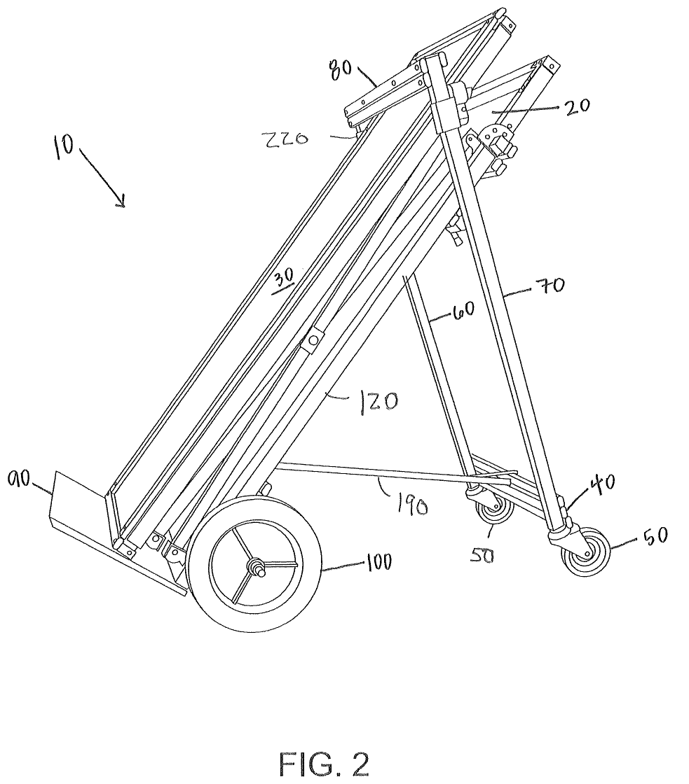

As shown in FIGS. 1-4, the versatile, multi-purpose materials handling cart 10 may be capable of performing a number of different type of operations based upon the particular configuration that the user adjusts the cart to perform the particular task at hand. Specifically, the multi-purpose cart 10 may easily transform in multiple configurations. First, the cart may be transformed or configured into a dolly, which is a wheeled cart used for moving large, heavy, or otherwise unwieldy objects (as best shown in FIGS. 1 and 2). Typically, the dolly is positioned in its standard upright condition shown in FIG. 1 and a user may slide the dolly's bottom plate 90 under the object being loaded and then the dolly is gently tilted backwards under the item's full weight is balanced over the wheels. As shown in FIG. 2, the dolly disclosed herein contains an additional feature for easier transport, wherein instead of solely relying on one set of wheels as is common with a standard dolly, a second set of wheels extends from the platforms for transport in a dolly configuration such that the platforms extend in an acute angle away from the arms.

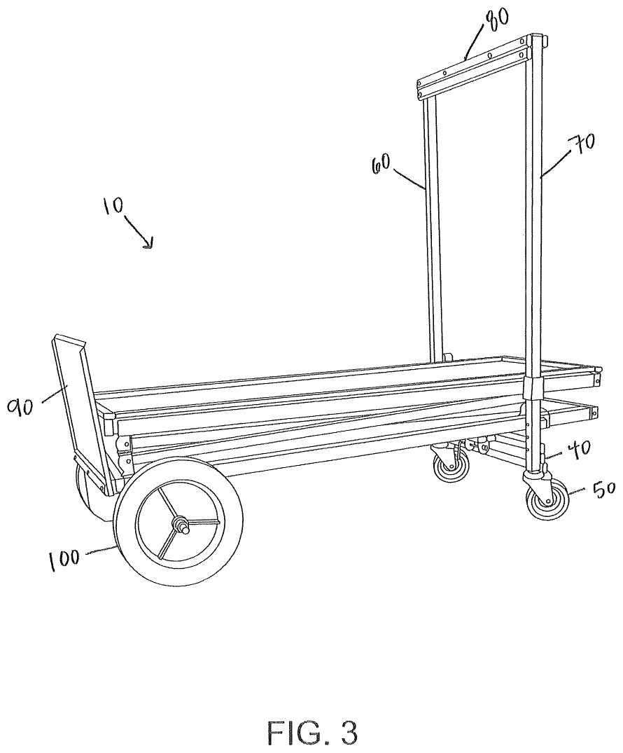

In addition to functioning as a dolly for transporting unwieldy objects, the cart 10 may be transformed or configured into a flatbed hand truck or trolley for transporting and hauling heavy materials and equipment (as best shown in FIG. 3) in a flat configuration rather than upright like the dolly. A flatbed trolley is a common form of freight transport in distribution environments for moving bulk loads. A flatbed trolley may aid in reducing effort required by the worker to move a load by allowing the user to pull or push instead of lift and carry. A relatively simple design offers a basic flat platform with four wheels and a fixed handle which is used to either push or pull the platform with the load on the platform and also provides steering capability.

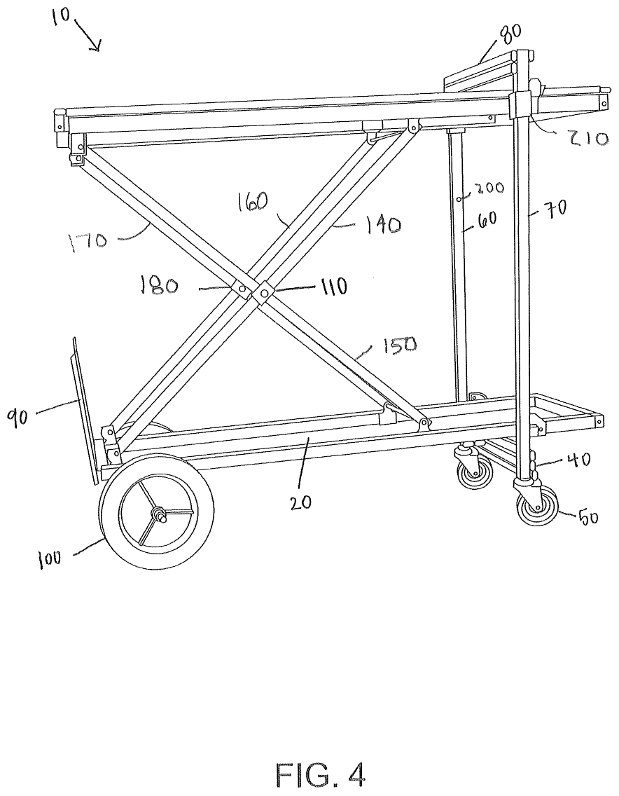

Finally, the cart 10 may be transformed or configured into an adjustable height lift cart for easily lifting and moving items to different heights by vertically moving the platform (as best shown in FIG. 4). Specifically, the adjustable height lift cart is designed to minimize a user's bending and lifting by efficiently lowering the top platform to a safe transporting height.

Due to its intended use both in terms of the work site environment and its function, i.e., transporting heavy equipment and materials, the cart must be strong and durable. As such, it is typically made of a rigid material, such as metal and hard plastic. As shown in FIG. 1, the cart 10 includes a first or top platform 30. The first platform 30 includes a substantially rectangular body 130 that surrounds a metal top face, which is both durable and easy to clean. In the closed configuration shown in FIG. 1, the first platform 30 is stacked essentially flush with a second or bottom platform 20. The second platform 20 is similarly shaped as the first platform with a substantially rectangular body 120 and a metal top face that is recessed within the body. The recessed nature of the top face allows it to receive the crisscrossed beams (discussed below) when they are not extended.

As perhaps best shown in FIG. 2, the cart 10 is supported by a plurality of wheels, including a first set of smaller wheels 50 and a second set of larger wheels 100, providing mobility to cart 10 when in each configuration. Typically, the first set of smaller wheels 50 may be at the front end of the cart 10, and the second set of larger wheels 100 may be at the back end of the cart 10. In the illustrated embodiment, the first set of smaller wheels 50 are caster wheels, which allow for enhanced mobility and maneuverability of the cart. The second set of larger wheels 100 are fixed to the second platform 30.

The cart 10 includes a first arm 60 extending from one of the first set of smaller wheels 50. The cart 10 also includes a second arm 70 extending from the other one of the first set of smaller wheels 50. The first and second arms 60, 70 are connected at a bottom by a base or support bar 40. The base 40 includes one or more rigid horizontal bars extending between the arms 60, 70 to provide support, especially when the cart 10 is in the flatbed hand truck and adjustable height lift cart configurations.

The base 40 may be welded or connected to each of the arms 60, 70 by one or more fasteners, like screws or bolts. The first and second arm 60, 70 may provide structural, weight-bearing support to the cart 10 in each of the three configurations. The first and second arms 60, 70 are also connected together by a crossbar 80 at an end opposite the first set of wheels 50 and the base 40. The crossbar 80 in conjunction with the arms 60, 70 and base 40 form a “pivoting handle” to allow a user to control and guide movement of the cart 10 in various directions. The pivoting handle allows a user to manually move the cart into the various configurations disclosed herein. It should be appreciated that the cart 10 may be automated by including an automotive control box. The control box may be positioned on top of the crossbar 80 to operate the cart 10 by allowing a user input controls to automatically move the cart in the various configurations rather than manual movement. The cart 10 may also alternatively be controlled by a remote control.

The pivoting handle is deployable by depressing buttons on quick release levers on each arm, i.e., first release lever 210 on arm 70 and second release lever 220 on arm 60 and then moving the pivoting up and down to proper place wherein the levers 210, 220 are locked into place. The release levers 210, 220 attached to the pivoting handle allow for easy reconfiguration between the three different configurations. The release levers 210, 220 may engage and disengage locking mechanisms that hold the cart's components in place. For example, the release levers 210, 220 fit in notches on the back of each arm to secure the handle in place and may be held in place by latches or some other type of locking means. This may allow cart 10 to be quickly and easily transformed into different configurations, depending on the user's needs.

The crossbar 80 includes one or more rigid horizontal bars extending between the arms 60, 70. The crossbar 80 may be welded or connected to each of the arms 60, 70 by one or more fasteners, like screws or bolts. A locking or securing bar 190 may be used to provide further support in the dolly position. When the dolly is not being used, the locking or securing bar 190 is positioned on the back of the platform 20.

As perhaps best shown in FIG. 3, a rear guard or plate 90 may be attached to the back end of the cart 10 (the end with the second set of larger wheels 100 in the flatbed truck or trolley, and adjustable height lift cart configurations). The rear guard 90 may be made of a rigid material, such as hard rubber or plastic. In more detail, the plate 90 is connected to the second platform 30 by fasteners or other connection means. The bottom edge of the top platform 30 is substantially flush with plate 90 when in the upright dolly configuration (FIG. 1) and the transport dolly configuration (FIG. 2). The plate 90 serves a number of functions depending on the particular configuration.

As shown in FIG. 1, when the cart is being utilized as a dolly, a user may slide the plate 90 under the object being loaded and then the dolly is gently tilted backwards under the item's full weight is balanced over the wheels. As shown in FIG. 2, the plate 90 is used to provide a platform to “hold” the item/object being transported in the transport dolly configuration. The dolly configuration may allow for easy transport of heavy items. In this configuration, as shown in FIGS. 1 and 2, the platforms 20, 30 are not spaced apart. Rather, they may be stacked together and tilted to approximately a forty-five degree angle (as best shown in FIG. 2), such that items may be placed on the platforms and supported by the rear guard 90 during transport. Once tilted, the arms 60, 70 are manually extended away from the platforms such that the first set of smaller wheels touch the ground to aid in transport in the transport dolly configuration (see FIG. 2). As shown in FIG. 2, in this arrangement, the platforms 20, 30 extend in an acute angle away from the arms 60, 70. The angle may be substantially 45 degrees to aid in transporting items on the dolly.

Turning to the flatbed hand truck configuration shown in FIG. 3, this configuration may enable users to move larger items, such as lumber, bricks, scaffolding and steel beams. Like in the dolly configuration, the platforms 20, 30 may be stacked together in the flatbed hand truck configuration. Further, in both the dolly configuration and flatbed hand truck configuration, a set of crisscrossed beams (discussed below) may be in a compressed position between the platforms 20, 30. In this configuration, the plate 90 can serve as a barrier to prevent items being transported from falling off the cart 10.

As illustrated in FIG. 4, the adjustable height lift cart configuration may provide a versatile solution for lifting and moving items to different heights. As shown in FIG. 4, the adjustable height lift cart is shown in full height position, wherein the release levers are secured in detents at the top of each arm. Alternatively, the adjustable height lift cart may be positioned at a half or middle height by raising the top platform 30 approximately halfway up the arms 60, 70 and locking levers 210, 220 in detents 200 positioned halfway up each arm. The mechanism to move the cart into the adjustable height lift configuration is the use of linked, folding supports in a crisscross or X pattern, known as a pantograph. The upward motion is achieved by applying pressure to the outside of the lowest set of supports which elongates the crossing pattern, and propels the top or work platform vertically. The top or second platform 30 may separate from the first or bottom platform 20 by a pair of crisscrossed beams on opposite sides of the cart, that move in a scissor-like way by means of a fixed central pivot joint 110, 180 on each side. In this configuration, a first pair of beams 140, 150 may be in an extended, or semi-extended position, depending on the user's needed height of use, between platforms 20, 30. In this configuration, a second pair of beams 160, 170 may be in an extended, or semi-extended position, depending on the user's needed height of use, between platforms 20, 30. The contraction of the scissor action can be hydraulic, pneumatic, mechanical or manually. In the illustrated embodiment, the adjustable height lift cart is moved manually as the user simply uses his hands to pull the top platform 30 away from the bottom platform 20 and continues to apply pulling force until it is at appropriate height and can be locked into place.

The reconfigurable materials handling cart 10 is designed with durability and stability in mind. The cart 10 may be constructed with high-quality materials that can withstand heavy loads and repeated use. The design of the cart 10 may also ensure that the cart 10 remains stable and secure during use, reducing the risk of accidents or damage to the items being transported. The cart 10 may include lights for work at night or in conditions that are not well-lit as well as an audio function while in operation to warn others of movement and the like.

Overall, the reconfigurable materials handling cart 10 may provide a versatile and efficient solution for moving heavy and bulky items in a variety of settings. Its unique design and functionality may make it an ideal choice for a wide range of industries, including manufacturing, warehousing, and logistics.

The foregoing descriptions of various embodiments have been presented for purposes of illustration and description. These descriptions are not intended to be exhaustive or to limit the invention to the precise forms disclosed. The embodiments described provide the best illustration of the inventive principles and their practical applications to thereby enable one of ordinary skill in the art to utilize the disclosure in various embodiments and with various modifications as are suited to the particular use contemplated.

1. A materials handling cart, comprising:
a first platform connected to a second platform via a pair of crisscrossed arms, whereby the second platform is configurable between a closed position with the first platform and an open position wherein the second platform is spaced from the first platform;
a base including a first set of wheels;
a cross bar connected to the base via a first arm and a second arm; and
a second set of wheels connected to the first platform,
whereby the cart is configured to change between the closed position and the open position.

2. The materials handling cart according to claim 1, further including a rear guard connected to the first platform.

3. The materials handling cart according to claim 1, wherein the first and second platforms are made of metal.

4. The materials handling cart according to claim 1, wherein the first and second platforms are parallel to one another in the open position and the closed position.

5. The materials handling cart according to claim 4, wherein the pair of crisscrossed arms are collapsed between the first and second platforms in the closed position.

6. The materials handling cart according to claim 5, wherein the pair of crisscrossed arms are extended in a X-shape between the first and second platforms in the open position.

7. The materials handling cart according to claim 1, wherein the closed position is a dolly position.

8. The materials handling cart according to claim 1, wherein the closed position is a flatbed hand truck position.

9. The materials handling cart according to claim 1, wherein the open position is an adjustable height lift cart position.

10. A reconfigurable utility cart movable between a first arrangement, a second arrangement, and a third arrangement, comprising:
a top platform and a bottom platform, wherein the first and second platforms are joined by a pair of scissor lift support bars;
a support bar including a plurality of front wheels;
a cross bar connected to the support bar via a first arm and a second arm;
a plurality of rear wheels fixed to the bottom platform; and
a plate connected to the top platform.

11. The reconfigurable utility cart of claim 10, wherein the top platform is configured to stack on top the bottom platform in the first and the second arrangement.

12. The reconfigurable utility cart of claim 10, wherein the pair of scissor lift support bars fit between the first and second platforms in a closed position in the first arrangement and second arrangement.

13. The reconfigurable utility cart of claim 10, wherein the first and second arms and the support bar are configured to swing away from the top and bottom platform such that the top and bottom platforms form an acute angle with the first and second arms.

14. The reconfigurable utility cart of claim 13, wherein the acute angle is substantially 45 degree angle.

15. The reconfigurable utility cart of claim 10, further comprising a fixed pivot joint at the center of each pair of scissor lift support bars, allowing compression and extension of the scissor lift support bars between varying arrangements.

16. The reconfigurable utility cart of claim 10, wherein each pair of scissor lift support bars are configured into an extended position such that the top and bottom platforms are spaced apart in the third arrangement.

17. The reconfigurable utility cart of claim 10, wherein the plurality of rear wheels are larger than the plurality of front wheels.

18. The reconfigurable utility cart of claim 17, wherein the plurality of rear wheels are fixedly mounted to the support bar.

19. The reconfigurable utility cart of claim 18, wherein the plurality of front wheels are castor wheels.

20. A method for configuring a materials handling cart from a first position to a second position to a third position, comprising:
providing a top platform and a bottom platform including a pair of X-shaped arms, a base including a first set of wheels, a cross bar connected to the base via a first arm and a second arm, a second set of wheels connected to the first platform;
positioning the top and bottom platforms in a stacked configuration such that the top and bottom platforms are parallel with the ground in a first position;
extending the top and bottom platforms to the cross bar such that the top and bottom platforms are perpendicular with the ground in a second position;
returning the top and bottom platforms to the first position; and
extending the pair of X-shaped arms via a central fixed pivot such that the top and bottom platforms are spaced apart in a third position.
